(19) United States
(12) Patent Application Publication
(10) Pub. No.: US 2009/0319297 A1
(43) Pub. Date: Dec. 24, 2009

(54) Workplace Absenteeism Risk Model

(75) Inventors: Gerardina M. Hernandez, Pittsburgh, PA (US); Pamela B. Peele, Pittsburgh, PA (US)

Correspondence Address: UPMC, U.S. STEEL TOWER, SUITE 6082, 600 GRANT STREET, PITTSBURGH, PA, 15219, US

(73) Assignee: UPMC, Pittsburgh, PA (US)

(21) Appl. No.: 12/486,800

(22) Filed: Jun. 18, 2009

Related U.S. Application Data
(60) Provisional application No. 61/073,384, filed on Jun. 18, 2008.

(51) Int. Cl. G06Q 50/00; G06N 5/04; G06N 3/02

(52) U.S. Cl. 705/2; 706/52; 706/21; 705/1

(57) ABSTRACT

A computer-implemented process includes: collecting a plurality of data; implementing a model that uses the data to estimate or predict lost work time at an individual level; and computing absenteeism risk at the individual level. The model can include, for example an artificial neural network or a model that uses regression analysis.

### CROSS-REFERENCE TO RELATED APPLICATION

This application claims the benefit of U.S. Provisional Patent Application Ser. No. 61/073,384, filed Jun. 18, 2008, which is hereby incorporated by reference.

### FIELD OF THE INVENTION

This invention relates to the fields of Medical Informatics; Health Economics; and Labor Economics.

### BACKGROUND OF THE INVENTION

Numerous models exist in the health care and insurance industry focused on estimating or predicting medical expenditures in order to define population health risk. A major component of the direct cost of medical illnesses and conditions among working populations is lost work time (absenteeism). It would be desirable to be able to estimate or predict lost work time and use it to assist in transforming individual behavior and health status.

### SUMMARY OF THE INVENTION

A computer-implemented process includes: collecting a plurality of data; implementing a model that uses the data to estimate or predict lost work time at an individual level; and computing absenteeism risk at the individual level.

### BRIEF DESCRIPTION OF THE DRAWINGS

FIG. 1 is a conceptual block diagram of an embodiment of the invention.

FIG. 2 is an example of absenteeism categories.

FIG. 3 is an example of the output of the model in the form of a graph of the total absenteeism risk for employees aggregated by particular medical conditions relative to the total absenteeism risk corresponding to the reference population.

### DETAILED DESCRIPTION OF THE INVENTION

In a first aspect, the invention provides a computer-implemented process comprised of models for estimating or predicting an employee's lost work time and generating an employee's absenteeism risk.

The process can enable employers, health care providers, health insurers, and policy makers to establish specific programs to monitor and reduce absenteeism, thusly modifying or transforming an employee's actual behavior and health.

The process can identify high risk employees based on workplace absenteeism. The concrete results of this invention can also serve as an input in other studies or models or applications to discover patterns based on historical data to identify tangible health-related problems. Consequently, health and human capital enhancing programs with specific goals and interventions can be created to alter actual employee behavior. This is an employee-centered approach. Also, absenteeism risk can be used as a tangible measure to evaluate and assess the outcomes of health and human capital enhancing programs.

As used in this description, workplace absenteeism is defined as the amount of time away from work; accidentally or intentionally. Lost work time can be associated with a variety of categories of workplace absence that can be defined in many ways and customized to the needs of any population of employees.

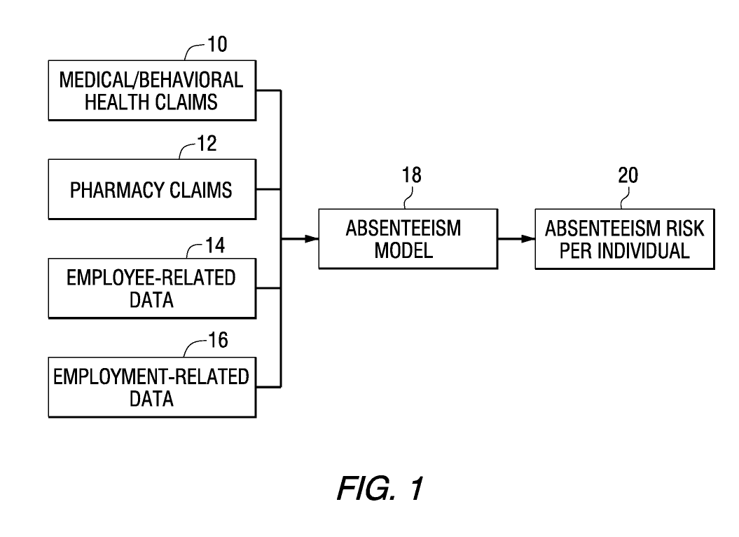

FIG. 1 is a conceptual block diagram of an embodiment of the invention. Using a software application housed on computer hardware, data at the individual employee level that comprise medical/behavioral health claims 10, pharmacy claims 12, employee-related data (e.g., health insurance enrollment information, demographics, age, sex) 14, and employment-related data 16 are collected. Then these data are processed using a model 18 that estimates or predicts lost work time per individual of the population being studied. Consequently, absenteeism risk for each individual is computed based on the reference population being studied 20. These results can be summarized and organized at any level necessary for the user's objective; for example, from granular employee-level results to fully aggregated employee population results. Also, these results can be reported in a variety of formats, for example: lost time risk; lost time hours; lost time summaries including risk, hours and cost; or lost time risk by type for chronic medical conditions or by pharmaceutical class or by medical services used or by employee/employer characteristics.

The model can be implemented using a software application housed on computer hardware. As used in this description, the term “software application” refers to a commercial software application that may comprise, but is not limited to, the following solutions: SAS Enterprise Miner (data mining solution), SAS/STAT (statistical solution), SAS/ACCESS (database interface), and Base SAS.

Medical diagnosis data can be taken from insurance claims data. The International Classification of Disease (ICD) coding can be used. ICD diagnosis codes are aggregated into groups as defined by the Clinical Classification System (CCS). The details of the CCS system are publicly available from the Agency for Health Care Research and Quality (AHRQ). Aggregated diagnosis codes are inputs for the invention. The invention is not limited to using these particular coding systems; any mutually exclusive coding system can be used.

Medical services can be identified from insurance claims data using Current Procedural Terminology (CPT) codes and Healthcare Common Procedure Coding System (HCPCS) codes. The CPT and HCPCS codes are aggregated into medical services groupings as defined by the Berenson-Eggers Type of Service (BETOS). Both HCPCS and BETOS are publicly available from the Centers for Medicare and Medicaid Services. CPT codes are the property of the American Medical Association and available for purchase from them. The BETOS codes are used as inputs. The invention is not limited to using these particular coding systems; any mutually exclusive coding system can be used.

Medication data can be identified from insurance claims data using the Pharmaceutical Therapeutic Class Code, which is publicly available from First Data Bank. In one embodiment, a variable-reduction method is employed using a software application to generate or create medication group variables. The resulting RX-groups are used as inputs. The invention need not use a particular medication coding system; any mutually exclusive coding system can be used.

Lost work hours (absenteeism) can be identified from time card coding data and can be defined according to user-specific criteria. Time card codes are employer-specific without a standard metric. Time card codes can be aggregated according to the needs of the user. For example, all types of paid time off can be lumped into one category or assigned to various subcategories such as scheduled and unscheduled time off. Scheduled, unscheduled, workers' compensation time, and short-term disability time are logical divisions of absenteeism but not the only ones that can be used. Depending on the user's needs, absenteeism hours could be defined in many ways. The definition of the category of absence is user-defined. The time card codes that are aggregated into the user-defined categories of absence are limited to whatever level of granularity an employer maintains in their time cards.

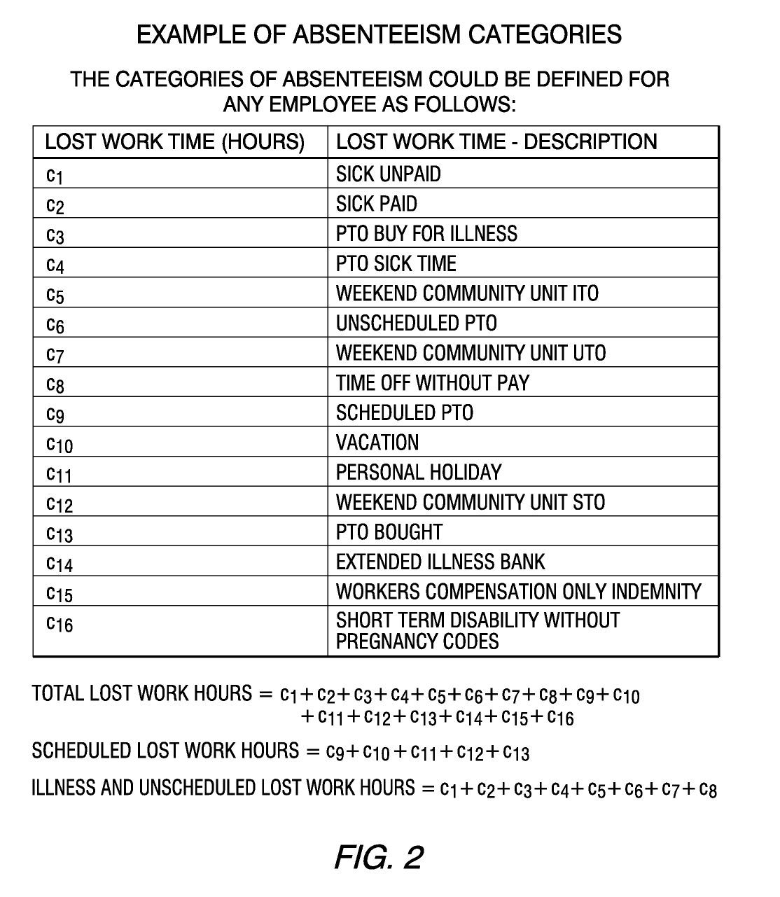

FIG. 2 illustrates some absenteeism categories that can be used in an embodiment of this invention.

In some embodiments, a software application is used to construct models using artificial neural networks. The artificial neural networks implemented in one embodiment of this invention are Multilayer Perceptrons (MLPs) with advanced optimization methods or algorithms for supervised learning. The number of hidden units varies by model. Also, each model uses a testing set to test the performance of the network. In the deployment phase, a fitted model can be applied on a new data set where the target is unknown. Thus, a fitted model can be used to produce an estimate of an unknown target value given a new data set.

In an embodiment of the invention, a software application is used to construct a model (item 18 in FIG. 1) that uses an artificial neural network where the target is Total Lost Work Hours for the year X+1 and the inputs are age, sex, a variable that indicates if the employee has dependents, variables for CCS codes, variables for RX-groups, and variables for BETOS codes. These inputs represent information corresponding to year X. This prospective approach predicts Total Lost Work Hours for the next year and uses the assumption that each individual will be an employee for the entire predicted year time frame.

In another embodiment of the invention, a software application is used to construct a model (item 18 in FIG. 1) that uses an artificial neural network where the target is Total Lost Work Hours for the year X+1 and the inputs are age, sex, a variable that indicates if the employee has dependents, variables for CCS codes, variables for RX-groups, and variables for BETOS codes and actual Total Lost Work Hours for year X. These inputs represent information corresponding to year X. This prospective approach predicts Total Lost Work Hours for the next year and uses the assumption that each individual will be an employee for the entire predicted year time frame.

In some other embodiments of the invention, a software application is used to construct a model for each selected absence category. Each model uses an artificial neural network where the target is lost work hours for the respective absence category for the year X and the inputs are age, sex, a variable that indicates if the employee has dependents, variables for CCS codes, variables for RX-groups, and variables for BETOS codes. These inputs represent information corresponding to year X. Moreover, the selected absence categories are: Total Lost Work Hours; Scheduled Lost Work Hours; Illness and Unscheduled Lost Work Hours; Workers' Compensation Only Indemnity; and Short-Term Disability (excluding maternity events). However, this approach could be applied to any user-defined absence category as long as a corresponding artificial neural network is implemented and tested.

In some other embodiments of the invention, a software application is used to construct models using multiple regression analysis. A model is constructed for each selected absence category. Each model employs a multiple linear regression with stepwise selection where the dependent variable is lost work hours for the respective absence category for the year X and the explanatory variables are age, sex, a variable that indicates if the employee has dependents, variables for CCS codes, variables for RX-groups, and variables for BETOS codes. These independent or explanatory variables represent information corresponding to year X. The categorical variables have only two categories—binary variables. Moreover, the selected absence categories are: Total Lost Work Hours; Scheduled Lost Work Hours; Illness and Unscheduled Lost Work Hours; Workers' Compensation Only Indemnity; and Short-Term Disability (excluding maternity events). However, this approach could be applied to any user-defined absence category as long as a corresponding model is built using multiple regression analysis. In the deployment phase, a fitted model can be applied on a new data set where the dependent variable is unknown. Thus, a fitted model can be used to obtain a predicted value of the dependent variable.

In block 20 of FIG. 1, the absenteeism risk for each employee is computed. This risk can be a number ranging from zero to infinity. The interpretation of the absenteeism risk generated is as follows: an employee with a risk equal to 1 has an estimated or predicted lost work time equal to the mean of the estimated or predicted lost work time for the reference population. An absenteeism risk above or below 1 indicates that the employee's estimated or predicted lost work time is higher or lower, respectively, than the mean of the estimated or predicted lost work time for the reference population.

Absenteeism risks are computed separately for any definable category of absenteeism that represents a reference population. Hence the invention could cover a large number of models as there are many ways to categorize absenteeism.

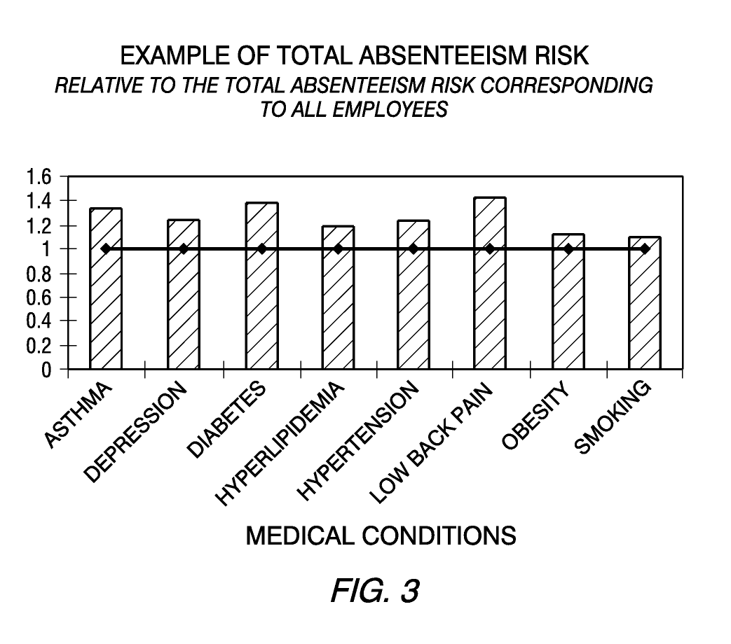

FIG. 3 is an example of the output of a model in the form of a graph of the total absenteeism risk for employees aggregated by particular clinical and medical conditions relative to the total absenteeism risk for the reference population.

It should be understood that the invention is not limited to the particular parameters described herein, but can include other inputs that may be used to improve the model should other data become accessible in the future.

The invention could be implemented in a model that utilizes a large number of parameters, which could include, without limitation, individual data; medical data (including medical and pharmacy billing data, and clinical data); and employment data. Such data may include for example, information related to medical and pharmacy claims (including diagnoses and procedures), actual medical laboratory values, health risk assessments, clinical disease management information, hospital billings and discharge data, pre-notification or authorization information, care management data, employee time card information, and employee personnel file information.

As can be seen from the above description, a computer-implemented process includes models for estimating or predicting an employee's lost work time and generating an employee's absenteeism risk. Using a software application, the process for each model can include: collecting a plurality of data, processing the data, implementing a model for estimating or predicting lost work time at the individual level and computing absenteeism risk at the individual level. Absenteeism is defined as the amount of time away from work; accidentally or intentionally. In various embodiments, the invention can enable employers, health care providers, health insurers, and policy makers to establish specific programs to monitor and reduce absenteeism, thus modifying or transforming an employee's actual behavior and health. This invention can identify high risk employees based on workplace absenteeism. The concrete results produced by the process can also serve as an input in other studies or models or applications to discover patterns based on historical data to identify tangible health-related problems. Consequently, health and human capital enhancing programs with specific goals and interventions can be created to alter actual employee behavior. This is an employee-centered approach. Also, absenteeism risk can be used as a tangible measure to evaluate and assess the outcomes of health and human capital enhancing programs.

While the invention has been described in terms of several embodiments, it will be apparent that various changes can be made to the described embodiments without departing from the scope of the invention as set forth in the following claims.

What is claimed is:

1. A computer-implemented process comprising:
collecting a plurality of data;
implementing a model that uses the data to estimate or predict lost work time at an individual level; and
computing absenteeism risk at the individual level.

2. The computer-implemented process of claim 1, wherein absenteeism comprises an amount of time away from work; accidentally or intentionally.

3. The computer-implemented process of claim 1, wherein the data includes International Classification of Disease (ICD) codes.

4. The computer-implemented process of claim 3, wherein the International Classification of Disease (ICD) diagnosis codes are aggregated into groups as defined by the Clinical Classification System.

5. The computer-implemented process of claim 1, wherein the data includes Current Procedural Terminology (CPT) codes and Healthcare Common Procedure Coding System (HCPCS) codes.

6. The computer-implemented process of claim 5, wherein the Current Procedural Terminology (CPT) codes and Healthcare Common Procedure Coding System (HCPCS) codes are aggregated into medical services groupings as defined by the Berenson-Eggers Type of Service.

7. The computer-implemented process of claim 1, wherein the data includes Pharmaceutical Therapeutic Class Code.

8. The computer-implemented process of claim 7, wherein a variable-reduction method is employed over the Pharmaceutical Therapeutic Class Codes to generate RX-groups.

9. The computer-implemented process of claim 1, wherein the model includes an artificial neural network.

10. The computer-implemented process of claim 9, wherein the artificial neural network is implemented using Multilayer Perceptrons (MLPs).

11. The computer-implemented process of claim 9, wherein the model uses a testing set to test the performance of the artificial neural network.

12. The computer-implemented process of claim 9, wherein in a deployment phase, a fitted model is applied on a new data set where a target value is unknown, and the fitted model is used to produce an estimate of the unknown target value given the new data set.

13. The computer-implemented process of claim 9, wherein the artificial neural network has a target of Total Lost Work Hours for a year X+1, the input data are age, sex, a variable that indicates if the employee has dependents, variables for CCS codes, variables for RX-groups, and variables for BETOS codes, representing information corresponding to a year X; and the model predicts Total Lost Work Hours for the year X+1 and assumes that each individual will be an employee for the entire predicted year time frame.

14. The computer-implemented process of claim 9, wherein the artificial neural network has a target of Total Lost Work Hours for a year X+1, the input data are age, sex, a variable that indicates if the employee has dependents, variables for CCS codes, variables for RX-groups, and variables for BETOS codes, and actual Total Lost Work Hours for a year X, representing information corresponding to year X; and the model predicts Total Lost Work Hours for the year X+1 and assumes that each individual will be an employee for the entire predicted year time frame.

15. The computer-implemented process of claim 9, wherein the artificial neural network has a target of lost work hours for an absence category for a year X, and the input data are age, sex, a variable that indicates if the employee has dependents, variables for CCS codes, variables for RX-groups, and variables for BETOS codes, representing information corresponding to year X.

16. The computer-implemented process of claim 15, wherein the absence category comprises at least one of: Total Lost Work Hours; Scheduled Lost Work Hours; Illness and Unscheduled Lost Work Hours; Workers' Compensation Only Indemnity; and Short-Term Disability.

17. The computer-implemented process of claim 1, wherein the model applies multiple regression analysis.

18. The computer-implemented process of claim 17, wherein the model is constructed for a selected absence category.

19. The computer-implemented process of claim 17, wherein the model employs a multiple linear regression with stepwise selection, the dependent variable is lost work hours for a year X, and explanatory variables include age, sex, a variable that indicates if the employee has dependents, variables for CCS codes, variables for RX-groups, and variables for BETOS codes, representing information corresponding to year X; and categorical variables have two categories.

20. The computer-implemented process of claim 18, wherein the absence category includes at least one of: Total Lost Work Hours; Scheduled Lost Work Hours; Illness and Unscheduled Lost Work Hours; Workers' Compensation Only Indemnity; and Short-Term Disability.

21. The computer-implemented process of claim 17, wherein for a deployment phase, a fitted model is applied on a new data set where a dependent variable is unknown, and the fitted model is used to obtain a predicted value of the dependent variable.

22. The computer-implemented process of claim 1, wherein the absenteeism risk for each employee is computed as a number ranging from zero to infinity, and an employee having an absenteeism risk equal to 1 has an estimated or predicted lost work time equal to a mean of an estimated or predicted lost work time for a reference population, an employee having an absenteeism risk above or below 1 indicates that the employee's estimated or predicted lost work time is higher or lower, respectively, than the mean of an estimated or predicted lost work time for the reference population.

23. The computer-implemented process of claim 1, wherein absenteeism risks are computed separately for a definable category of absenteeism that represents a reference population.
